(19) United States
(12) Patent Application Publication
(10) Pub. No.: US 2012/0285617 A1
(43) Pub. Date: Nov. 15, 2012

(54) METHOD FOR PRODUCING METAL FOIL LAMINATE

(75) Inventors: Shohei Azami, Tsukuba-shi (JP); Changbo Shim, Seo-gu (KR)

(73) Assignee: SUMITOMO CHEMICAL COMPANY, LIMITED, Chuo-ku, Tokyo (JP)

(21) Appl. No.: 13/497,705

(22) PCT Filed: Sep. 22, 2010
(86) PCT No.: PCT/JP2010/066409

§ 371 Date: Aug. 2, 2012

(30) Foreign Application Priority Data
Sep. 25, 2009 (JP) 2009-220105

(51) Int. Cl. B32B 37/16

(52) U.S. Cl. 156/306.6

(57) ABSTRACT

A method is provided for producing a metal foil laminate having a good appearance. In a suitable embodiment a first stack with a resin-impregnated base material sequentially sandwiched between a pair of copper foils and between a pair of spacer copper foils is prepared. Then, a second stack with the first stack sequentially sandwiched between a pair of SUS sheets and between a pair of aramid cushions is prepared. Thereafter, this second stack is hot pressed by a pair of heating plates in the laminating direction thereof to produce a metal foil laminate with a pair of copper foils attached onto both sides of the resin-impregnated base material.

### TECHNICAL FIELD

The present invention relates to a method for producing a metal foil laminate to be used as a material for a printed wiring board, for example.

### BACKGROUND ART

Multifunctionalization of electronic devices has acceleratively developed year by year. For such multifunctionalization, in addition to an improvement in a semiconductor package which has hitherto been promoted, higher performances have been demanded even in a printed wiring board on which electronic components are mounted. For example, in order to respond to a demand for a reduction in size and weight of electronic devices, the need for higher density of printed wiring boards has been increasing. Thus, multi-layering of wiring substrates, narrowing of wiring pitches and microminiaturization of via holes have been promoted.

Conventionally, a metal foil laminate, which is a material to be used for this printed wiring board, has been produced by laminating an electrical insulating material, for which a thermosetting resin such as a phenol resin or an epoxy resin is mainly used, and a conductive material, for which a metal foil such as a copper foil is mainly used, with a hot press, a heating roll or the like. Recently, a liquid crystal polyester excellent in heat resistance and electrical characteristics has attracted attention, and an application thereof to an insulating base material part of a metal foil laminate has been attempted as disclosed in, for example, Patent Literature 1.

When such a metal foil laminate is produced, an insulating base material is sandwiched between metal foils such as copper foils, directly placed between a pair of metal sheets such as SUS sheets, and hot pressed under reduced pressure using a pair of upper and lower heating plates of a hot press or the like, for example as disclosed in Patent Literature 2.

### CITATION LIST

### Patent Literature

Patent Literature 1: Japanese Patent Laid-Open No. 2007-106107

Patent Literature 2: Japanese Patent Laid-Open No. 2000-263577

### SUMMARY OF INVENTION

### Technical Problem

However, there have been the following problems about the above techniques.

First, if the metal sheet to be used upon the production of a metal foil laminate is repeatedly used, the surface state thereof is usually reduced to cause fine unevenness on the surface. Therefore, when this metal sheet is used to produce a metal foil laminate, the unevenness of the metal sheet is transferred on the surface of the metal foil laminate to cause unevenness on a copper foil, thereby reducing the appearance of the metal foil laminate. Here, in order to avoid such a problem, a solution in which the surface of the metal sheet is polished is also considered, but such a polishing step is adopted to cause disadvantages in terms of time and labor resulting in decreased productivity of the metal foil laminate, and thus the solution is poor in practicality.

Second, since the metal sheet is directly placed on the heating plates of the hot press, the quantity of heat to be transmitted from the heating plates to the metal foil laminate is increased to cause an excessive rise in temperature in some cases. If such an excessive rise in temperature is caused, there is a possibility that the metal foil of the metal foil laminate is oxidized and colored to thereby significantly impair the appearance of the metal foil laminate.

Thus, under such circumstances, an object of the present invention is to provide a method for producing a metal foil laminate, by which a metal foil laminate having a good appearance can be obtained.

### Solution to Problem

In order to achieve such an object, the present inventor has intensively studied, and thus has focused on interposing a spacer between each of metal foils and each of metal sheets which constitute a metal foil laminate, so as not to transfer unevenness of the surface of the metal sheet to the surface of the metal foil laminate to thereby cause unevenness on the metal foil; and interposing each of cushion materials between each of heating plates and each of the metal sheets, so as not to increase the quantity of heat to be transmitted from the heating plate to the metal foil laminate to thereby cause an excessive rise in temperature, and thus has completed the present invention.

Namely, a first aspect of the present invention relates to a method for producing a metal foil laminate provided with metal foils on both sides of an insulating base material, comprising a second stack-preparing step of preparing a second stack having a layered constitution in which a first stack with the insulating base material sequentially sandwiched between a pair of the metal foils and between a pair of spacers is sequentially sandwiched between a pair of metal sheets and between a pair of cushion materials; and a hot pressing step of hot pressing this second stack in the laminating direction thereof with a pair of heating plates.

According to a second aspect of the present invention, in addition to the constitution of the first aspect, the second stack is hot pressed under reduced pressure in the hot pressing step.

According to a third aspect of the present invention, in addition to the constitution of the first aspect or the second aspect, the metal foil is a copper foil.

According to a fourth aspect of the present invention, in addition to the constitution of any of the first aspect to the third aspect, the spacer is a spacer copper foil or a spacer SUS foil.

According to a fifth aspect of the present invention, in addition to the constitution of any of the first aspect to the fourth aspect, the metal sheet is a SUS sheet.

According to a sixth aspect of the present invention, in addition to the constitution of any of the first aspect to the fifth aspect, the cushion material is an aramid cushion.

According to a seventh aspect of the present invention, in addition to the constitution of any of the first aspect to the sixth aspect, the insulating base material is a prepreg in which a liquid crystal polyester is impregnated into an inorganic fiber or a carbon fiber.

According to an eighth aspect of the present invention, in addition to the constitution of the seventh aspect, the liquid crystal polyester is soluble in a solvent and the flow start temperature thereof is 250° C. or higher.

According to a ninth aspect of the present invention, in addition to the constitution of the seventh aspect or the eighth aspect, the liquid crystal polyester has structural units shown by Formulae (1), (2) and (3), wherein the proportion of the structural unit shown by Formula (1) is 30.0 to 45.0% by mole, the proportion of the structural unit shown by Formula (2) is 27.5 to 35.0% by mole, and the proportion of the structural unit shown by Formula (3) is 27.5 to 35.0% by mole, based on the total of all the structural units:

—O—Ar¹—CO— (1)

—CO—Ar²—CO— (2)

—X—Ar³—Y— (3)

wherein, Ar¹ represents phenylene or naphthylene, Ar² represents phenylene, naphthylene or a group shown by Formula (4), Ar³ represents phenylene or the group shown by Formula (4), and X and Y each independently represent O or NH, wherein hydrogen atoms bonded to aromatic rings represented by Ar¹, Ar² and Ar³ may be substituted with halogen atoms, alkyl groups or aryl groups

—Ar¹¹—Z—Ar¹²— (4)

wherein, Ar¹¹ and Ar¹² each independently represent phenylene or naphthylene, and Z represents O, CO or SO₂.

According to a tenth aspect of the present invention, in addition to the constitution of the ninth aspect, at least one of X and Y in the structural unit shown by Formula (3) is NH.

According to an eleventh aspect of the present invention, in addition to the constitution of any of the seventh aspect to the tenth aspect, the liquid crystal polyester contains 30.0 to 45.0% by mole of at least one structural unit of a structural unit derived from p-hydroxybenzoic acid and a structural unit derived from 2-hydroxy-6-naphthoic acid, 27.5 to 35.0% by mole of at least one structural unit of a structural unit derived from terephthalic acid, a structural unit derived from isophthalic acid and a structural unit derived from 2,6-naphthalenedicarboxylic acid, and 27.5 to 35.0% by mole of a structural unit derived from 4-aminophenol, based on the total of all the structural units.

In addition, a twelfth aspect of the present invention relates to a method for producing a metal foil laminate provided with metal foils on both sides of an insulating base material, comprising a second stack-preparing step of preparing a second stack in which a laminated structure, in which a plurality of first stacks with the insulating base material sequentially sandwiched between a pair of the metal foils and between a pair of spacers are stacked in the laminating direction thereof with a partition plate interposed therebetween, is sequentially sandwiched between a pair of metal sheets and between a pair of cushion materials; and a hot pressing step of hot pressing this second stack in the laminating direction thereof with a pair of heating plates.

### Advantageous Effects of Invention

According to the present invention, a spacer is interposed between each of metal foils and each of metal sheets which constitute a metal foil laminate, thereby making it possible to avoid a case where unevenness of the surface of the metal sheet is transferred to the surface of the metal foil laminate to cause unevenness on the metal foil. Moreover, a cushion material is interposed between each of heating plates and each of the metal sheets, thereby making it possible to avoid a case where the quantity of heat to be transmitted from the heating plate to the metal foil laminate is increased to cause an excessive rise in temperature. As a result, when a metal foil laminate is produced, a metal foil laminate having a good appearance can be obtained.

### BRIEF DESCRIPTION OF DRAWINGS

FIG. 1 is a perspective view showing a metal foil laminate according to Embodiment 1.

FIG. 2 is a cross-section view showing the metal foil laminate according to Embodiment 1.

FIG. 3 is a cross-section view showing a method for producing the metal foil laminate according to Embodiment 1.

FIG. 4 is a schematic configuration view of a hot press according to Embodiment 1.

FIG. 5 is a cross-section view showing a method for producing a metal foil laminate according to Embodiment 2.

FIG. 6 is a cross-section view showing a second stack according to Comparative Example 1.

FIG. 7 is a cross-section view showing a second stack according to Comparative Example 2.

### DESCRIPTION OF EMBODIMENTS

Hereinafter, embodiments of the present invention will be described.

### Embodiment 1

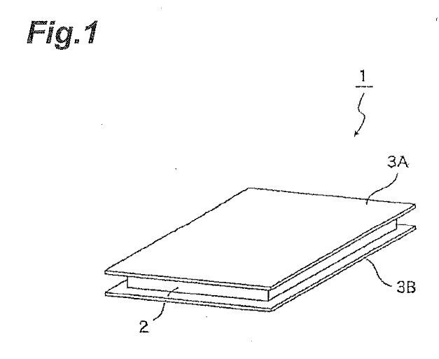

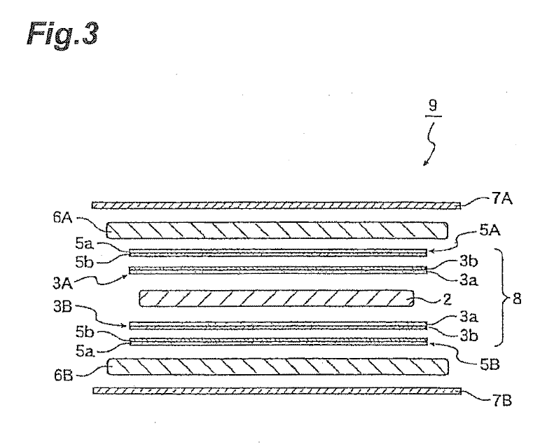

Embodiment 1 will be described with reference to FIG. 1 to FIG. 4. In Embodiment 1, a one-stage constitution, namely, a case where one metal foil laminate is produced by a single hot pressing will be described. In FIG. 3, the respective members are illustrated with being separated from one another for easy understanding.

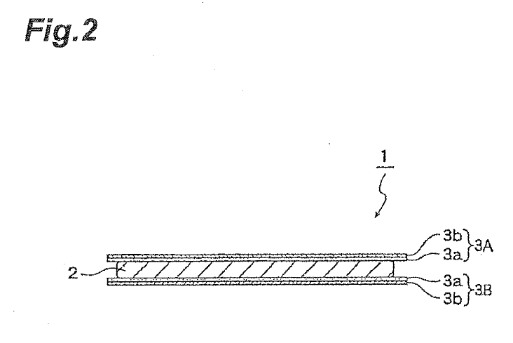

As shown in FIG. 1, a metal foil laminate 1 according to Embodiment 1 has a square plate-shaped resin-impregnated base material 2 (insulating base material). The resin-impregnated base material 2 is integrally attached with square sheet-shaped copper foils (metal foils) 3 (3A, 3B) on both upper and lower surfaces thereof, respectively. Here, as shown in FIG. 2, each of the copper foils 3 has a two-layered structure including a mat surface 3a and a shine surface 3b, and is in contact with the resin-impregnated base material 2 at the side of the mat surface 3a. The size of each of the copper foils 3 (one side of a square) is slightly larger than that of the resin-impregnated base material 2. In order to obtain a metal foil laminate 1 having satisfactory surface smoothness, it is desirable that each of the copper foils 3 have a thickness of 18 μm or more and 100 μm or less from the viewpoints of availability and ease of handling.

Here, the resin-impregnated base material 2 is a prepreg in which an inorganic fiber (preferably, a glass cloth) or a carbon fiber is impregnated with a liquid crystal polyester excellent in heat resistance and electrical characteristics. This liquid crystal polyester is a polyester having characteristics in which optical anisotropy is exhibited upon melting and an anisotropic melt is formed at a temperature of 450° C. or lower. The liquid crystal polyester to be used in the present embodiment is preferably one having a structural unit shown by Formula (1) (hereinafter, referred to as a “structural unit of Formula (1)”), a structural unit shown by Formula (2) (hereinafter, referred as to “structural unit of Formula (2)”) and a structural unit shown by Formula (3) (hereinafter, referred as to a “structural unit of Formula (3)”), wherein the proportion of the structural unit of Formula (1) is 30.0 to 45.0% by mole, the proportion of the structural unit of Formula (2) is 27.5 to 35.0% by mole, and the proportion of the structural unit of Formula (3) is 27.5 to 35.0% by mole, based on the total of all the structural units:

—O—Ar¹—CO— (1)

—CO—Ar²—CO— (2)

—X—Ar³—Y— (3)

wherein, Ar¹ represents phenylene or naphthylene, Ar² represents phenylene, naphthylene or a group shown by Formula (4), Ar³ represents phenylene or the group shown by Formula (4), and X and Y each independently represent O or NH, wherein hydrogen atoms bonded to aromatic rings represented by Ar¹, Ar² and Ar³ may be substituted with halogen atoms, alkyl groups or aryl groups

—Ar¹¹—Z—Ar¹²— (4)

wherein, Ar¹¹ and Ar¹² each independently represent phenylene or naphthylene, and Z represents O, CO or SO₂.

The structural unit of Formula (1) is a structural unit derived from an aromatic hydroxycarboxylic acid. Examples of this aromatic hydroxycarboxylic acid include para-hydroxybenzoic acid, meta-hydroxybenzoic acid, 2-hydroxy-6-naphthoic acid, 2-hydroxy-3-naphthoic acid, and 1-hydroxy-4-naphthoic acid. The structural unit of Formula (1) may have multiple kinds of structural units. In this case, the total of the structural units corresponds to the proportion of the structural unit of Formula (1).

The structural unit of Formula (2) is a structural unit derived from an aromatic dicarboxylic acid. Examples of this aromatic dicarboxylic acid include terephthalic acid, isophthalic acid, 2,6-naphthalenedicarboxylic acid, 1,5-naphthalene dicarboxylic acid, diphenylether-4,4′-dicarboxylic acid, diphenylsulfone-4,4′-dicarboxylic acid, and diphenylketone-4,4′-dicarboxylic acid. The structural unit of Formula (2) may have multiple kinds of structural units. In this case, the total of the structural units corresponds to the proportion of the structural unit of Formula (2).

The structural unit of Formula (3) is a structural unit derived from an aromatic diol, an aromatic amine having a phenolic hydroxyl group, or an aromatic diamine. Examples of this aromatic diol include hydroquinone, resorcin, 2,2-bis(4-hydroxy-3,5-dimethylphenyl)propane, bis(4-hydroxyphenyl)ether, bis-(4-hydroxyphenyl)ketone, and bis-(4-hydroxyphenyl)sulfone. The structural unit of Formula (3) may have multiple kinds of structural units. In this case, the total of the structural units corresponds to the proportion of the structural unit of Formula (3).

Moreover, examples of this aromatic amine having a phenolic hydroxyl group include 4-aminophenol (p-aminophenol) and 3-aminophenol (m-aminophenol). Examples of this aromatic diamine include 1,4-phenylene diamine and 1,3-phenylene diamine.

The liquid crystal polyester to be used in the present embodiment has solubility in a solvent. Such solubility in a solvent means that the liquid crystal polyester is dissolved in a solvent in a concentration of 1% by mass or more at a temperature of 50° C. In this case, the solvent is any one of suitable solvents to be used for preparing a liquid composition described later, and will be described later in detail.

Such a liquid crystal polyester having solubility in a solvent is preferably one including, as the structural unit of Formula (3), a structural unit derived from an aromatic amine having a phenolic hydroxyl group and/or a structural unit derived from an aromatic diamine. That is, it is preferable to include, as the structural unit of Formula (3), a structural unit in which at least one of X and Y is NH (structural unit shown by Formula (3′), hereinafter, referred to as “structural unit of Formula (3′)”) since the liquid crystal polyester tends to be excellent in solubility in a suitable solvent described later (aprotic polar solvent). It is particularly preferable that substantially all the structural units of Formula (3) be the structural units of Formula (3′). This structural unit of Formula (3′) has advantages of making solubility of the liquid crystal polyester in a solvent sufficient and also improving low water absorbability of the liquid crystal polyester:

—X—Ar³—NH— (3′)

wherein, Ar³ and X have the same meanings as in Formula (3).

It is more preferable to include the structural unit of Formula (3) within a range from 30.0 to 32.5% by mole, based on the total of all the structural units. This makes solubility in a solvent more satisfactory. The liquid crystal polyester having the structural unit of Formula (3′) as the structural unit of Formula (3) has also an advantage of more easily producing a resin-impregnated base material 2 using a liquid composition described later, in addition to the advantages in terms of solubility in a solvent and low water absorbability.

The structural unit of Formula (1) is preferably included within a range from 30.0 to 45.0% by mole, and more preferably within a range from 35.0 to 40.0% by mole, based on the total of all the structural units. The liquid crystal polyester including the structural unit of Formula (1) in such a mole fraction tends to be more excellent in solubility in a solvent while sufficiently maintaining liquid crystallinity. Furthermore, if considering together availability of an aromatic hydroxycarboxylic acid, from which the structural unit of Formula (1) is derived, p-hydroxybenzoic acid and/or 2-hydroxy-6-naphthoic acid are/is suitable as this aromatic hydroxycarboxylic acid.

The structural unit of Formula (2) is preferably included within a range from 27.5 to 35.0% by mole, and more preferably within a range from 30.0 to 32.5% by mole, based on the total of all the structural units. The liquid crystal polyester including the structural unit of Formula (2) in such a mole fraction tends to be more excellent in solubility in a solvent while sufficiently maintaining liquid crystallinity. Furthermore, if considering together availability of an aromatic dicarboxylic acid, from which the structural unit of Formula (2) is derived, at least one selected from the group consisting of terephthalic acid, isophthalic acid and 2,6-naphthalenedicarboxylic acid is preferable as this aromatic dicarboxylic acid.

In order that the obtained liquid crystal ester exerts a higher liquid crystallinity, the mole fraction of the structural unit of Formula (2) to the structural unit of Formula (3), represented by [structural unit of Formula (2)]/[structural unit of Formula (3)], is suitably within a range from 0.9/1.0 to 1.0/0.9.

Next, a method for producing a liquid crystal polyester will be briefly described.

A liquid crystal polyester can be produced by various known methods. In the case where a suitable liquid crystal polyester, namely, the liquid crystal polyester including the structural unit of Formula (1), the structural unit of Formula (2) and structural unit of Formula (3) is produced, a method for producing a liquid crystal polyester, in which a monomer, from which these structural units are derived, is converted into an ester-forming and amide-forming derivative and then polymerized, is preferable because the operation thereof is simple.

This ester-forming and amide-forming derivative will be described by way of examples.

Examples of the ester-forming and amide-forming derivative of a monomer having a carboxyl group, such as an aromatic hydroxycarboxylic acid or an aromatic dicarboxylic acid, include the following, namely, those in which the carboxyl group is a group having a high reaction activity such as an acid chloride or an acid anhydride so as to promote a reaction of producing a polyester or a polyamide, and those in which the carboxyl group forms an ester with alcohols, ethylene glycol or the like so as to produce a polyester or a polyamide by an ester exchange and amide exchange reaction.

Examples of the ester-forming and amide-forming derivative of a monomer having a phenolic hydroxyl group, such as an aromatic hydroxycarboxylic acid or an aromatic diol, include those in which the phenolic hydroxyl group forms an ester with carboxylic acids so as to produce a polyester or a polyamide by an ester exchange reaction.

Examples of the amide-forming derivative of a monomer having an amino group, such as an aromatic diamine, include those in which the amino group forms an amide with carboxylic acids so as to produce a polyamide by an amide exchange reaction.

Among them, a particularly preferable method for producing a liquid crystal polyester is as follows from the viewpoint of producing a liquid crystal polyester more simply: first, an aromatic hydroxycarboxylic acid, and a monomer having a phenolic hydroxyl group and/or an amino group such as an aromatic diol, an aromatic amine having a phenolic hydroxyl group, or an aromatic diamine are acylated with a fatty acid anhydride to obtain an ester-forming and amide-forming derivative (acylate); and then, the derivative is polymerized so that an acyl group of this acylate and a carboxylic group of a monomer having a carboxylic group result in ester exchange and amide exchange, to thereby produce a liquid crystal polyester.

Such a method for producing a liquid crystal polyester is disclosed in, for example, Japanese Patent Laid-Open No. 2002-220444 or Japanese Patent Laid-Open No. 2002-146003.

In the acylation, the amount of the fatty acid anhydride to be added is preferably from 1.0 to 1.2-fold equivalent, and more preferably from 1.05 to 1.1-fold equivalent, based on the total of the phenolic hydroxyl group and the amino group. If the amount of the fatty acid anhydride to be added is less than 1.0-fold equivalent, the acylate and a raw monomer tend to be sublimated upon polymerization to cause clogging of a reaction system. In contrast, if it is more than 1.2-fold equivalent, the obtained liquid crystal polyester tends to be remarkably colored.

The acylation is preferably carried out at 130 to 180° C. for 5 minutes to 10 hours, and more preferably carried out at 140 to 160° C. for 10 minutes to 3 hours.

The fatty acid anhydride to be used for the acylation is acetic anhydride, propionic anhydride, butyric anhydride, isobutyric anhydride or a mixture of two or more selected therefrom, from the viewpoints of price and handling properties. It is particularly preferably acetic anhydride.

The polymerization which follows the acylation is preferably carried out while raising a temperature from 130 to 400° C. at a rate of 0.1 to 50° C./minute, and more preferably carried out while raising a temperature from 150 to 350° C. at a rate of 0.3 to 5° C./minute.

In the polymerization, the amount of the acyl group of the acylate is preferably 0.8 to 1.2-fold equivalent based on that of the carboxyl group.

In the case of the acylation and/or polymerization, a fatty acid and an unreacted fatty acid anhydride to be produced as by-products are preferably distilled out of the system by evaporation or the like so as to shift the equilibrium by the Le Chatelier-Braun principle (principle of mobile equilibrium).

It is to be noted that the acylation and polymerization may be carried out in the presence of a catalyst. It is possible to use, as this catalyst, one which has been conventionally known as a catalyst for polymerizing a polyester. Examples include metal salt catalysts such as magnesium acetate, stannous acetate, tetrabutyl titanate, lead acetate, sodium acetate, potassium acetate, and antimony trioxide; and organic compound catalysts such as N,N-dimethylaminopyridine and N-methylimidazole.

Among these catalysts, a heterocyclic compound containing two or more nitrogen atoms, such as N,N-dimethylaminopyridine or N-methylimidazole is preferably used (see Japanese Patent Laid-Open No. 2002-146003).

This catalyst is usually simultaneously charged when a monomer is charged, and it is not necessarily required to be removed after the acylation. In the case where this catalyst is not removed, the acylation can be shifted to the polymerization as it is.

The liquid crystal polyester obtained in such polymerization can be used as it is in the present embodiment, but it is preferable, in order to further improve characteristics such as heat resistance and liquid crystallinity, to increase the molecular weight. Solid phase polymerization is preferably carried out so as to achieve such an increase in molecular weight. A series of operations according to this solid phase polymerization will be described below. The liquid crystal polyester having a comparatively low molecular weight obtained by the above polymerization is taken out and ground into a powder or flake. Subsequently, the liquid, crystal polyester after grinding is subjected to a heat treatment under an atmosphere of an inert gas such as nitrogen at 20 to 350° C. for 1 to 30 hours in a solid phase state, for example. These operations can allow the solid phase polymerization to be performed. This solid phase polymerization may be carried out while stirring, or may be carried out in a state of being left to stand without stirring. Here, from the viewpoint of obtaining a liquid crystal polyester having a suitable flow start temperature described later, the details of suitable conditions of this solid phase polymerization are as follows: the reaction temperature is preferably higher than 210° C., and more preferably within a range from 220 to 350° C., and the reaction time is preferably selected from 1 to 10 hours.

In the liquid crystal polyester to be used in the present embodiment, the flow start temperature is preferably 250° C. or higher in that a higher adhesion is obtained between a conductor layer to be formed on the resin-impregnated base material 2 and an insulating layer (resin-impregnated base material 2). As used herein, the flow start temperature refers to a temperature at which a melt viscosity of a liquid crystal polyester is 4800 Pa˜s or less under a pressure of 9.8 MPa in the evaluation of melt viscosity with a flow tester. It is to be noted that this flow start temperature is well known to a person with an ordinary skill in the art as an indication of the molecular weight of the liquid crystal polyester (see, for example, edited by Naoyuki Koide, “Synthesis, Forming and Application of Liquid Crystal Polymer”, pp. 95-105, CMC, issued on Jun. 5, 1987).

This flow start temperature of the liquid crystal polyester is more preferably 250° C. or higher and 300° C. or lower. If the flow start temperature is 300° C. or lower, the solubility in a solvent of the liquid crystal polyester is made more satisfactory and also the viscosity thereof does not remarkably increase when a liquid composition described later is obtained, and therefore, the handling properties of this liquid composition tends to be made satisfactory. From such a viewpoint, a liquid crystal polyester having a flow start temperature of 260° C. or higher and 290° C. or lower is more preferable. Here, in order to control the flow start temperature of the liquid crystal polyester within such a suitable range, polymerization conditions of the solid phase polymerization may be appropriately optimized.

Here, the resin-impregnated base material 2 is particularly preferably one obtained by impregnating an inorganic fiber (preferably, a glass cloth) or a carbon fiber with a liquid composition containing a liquid crystal polyester and a solvent (particularly a liquid composition obtained by dissolving a liquid crystal polyester in a solvent), and then removing the solvent by drying. The amount of the liquid crystal polyester which adheres to the resin-impregnated base material 2 after removing the solvent is preferably from 30 to 80% by mass, and more preferably 40 to 70% by mass, based on the mass of the obtained resin-impregnated base material 2.

In the case where the above-described suitable liquid crystal polyester, in particular, the liquid crystal polyester including the above-described structural unit of Formula (3′) is used as the liquid crystal polyester to be used in the present embodiment, this liquid crystal polyester exerts sufficient solubility in an aprotic solvent containing no halogen atom.

Examples of the aprotic solvent containing no halogen atom include ether-based solvents such as diethylether, tetrahydrofuran, and 1,4-dioxane; ketone-based solvents such as acetone and cyclohexanone; ester-based solvents such as ethyl acetate; lactone-based solvents such as γ-butyrolactone; carbonate-based solvents such as ethylene carbonate and propylene carbonate; amine-based solvents such as triethylamine and pyridine; nitrile-based solvents such as acetonitrile and succinonitrile; amide-based solvents such as N,N-dimethylformamide, N,N-dimethylacetamide, tetramethylurea, and N-methylpyrrolidone; nitro-based solvents such as nitromethane and nitrobenzene; sulfur-based solvents such as dimethyl sulfoxide and sulfolane; and phosphorous-based solvents such as hexamethylphosphoric acid amide and tri-n-butylphosphoric acid. It is to be noted that the above-described solubility in a solvent of the liquid crystal polyester refers to solubility in at least one aprotic solvent selected from these solvents.

From the viewpoint of making solubility in a solvent of the liquid crystal polyester more satisfactory to thereby easily obtain a liquid composition, it is preferable to use an aprotic polar solvent having a dipole moment of 3 or more and 5 or less among the exemplified solvents. Specifically, it is preferable to use an amide-based solvent or a lactone-based solvent, and it is more preferable to use N,N-dimethylformamide (DMF), N,N-dimethylacetamide (DMAc) or N-methylpyrrolidone (NMP). Furthermore, when the solvent is a high volatility solvent having a boiling point of 180° C. or lower at 1 atm, there is an advantage that it is easy to remove the solvent after impregnating a sheet (inorganic fiber or carbon fiber) with a liquid composition. From this viewpoint, DMF and DMAc are particularly preferable. The use of such an amide-based solvent also has an advantage that thickness unevenness or the like is less likely caused in the production of the resin-impregnated base material 2, to thereby easily form a conductor layer on this resin-impregnated base material 2.

When the above-described aprotic solvent is used in the liquid composition, the liquid crystal polyester is preferably dissolved in an amount of 20 to 50 parts by mass, and more preferably 22 to 40 parts by mass, based on 100 parts by mass of this aprotic solvent. When the content of the liquid crystal polyester in the liquid composition is within such a range, efficiency of impregnating the sheet with the liquid composition is made satisfactory in the production of the resin-impregnated base material 2, and thus there is a tendency of hardly causing a disadvantage that thickness unevenness or the like is caused when the solvent is removed by drying after the impregnation.

As long as the object of the present invention is not impaired, to the liquid composition may be added one or two or more resin(s) other than the liquid crystal polyester, for example, thermoplastic resins such as polypropylene, polyamide, polyester, polyphenylene sulfide, polyetherketone, polycarbonate, polyethersulfone, polyphenylether and a modified product thereof, and polyetherimide; elastomers typified by a copolymer of glycidyl methacrylate and polyethylene; and thermosetting resins such as a phenol resin, an epoxy resin, a polyimide resin, and a cyanate resin. However, when such other resins are used, these resins are also preferably soluble in the solvent to be used in the liquid composition.

Furthermore, as long as the effects of the present invention are not impaired, to the liquid composition may be added one or two or more kinds of various additives, for example, inorganic fillers such as silica, alumina, titanium oxide, barium titanate, strontium titanate, aluminum hydroxide, and calcium carbonate; organic fillers such as a cured epoxy resin, a crosslinked benzoguanamine resin, and a crosslinked acrylic polymer; silane coupling agents, antioxidants, and ultraviolet absorbers; for the purpose of improvements in dimension stability, pyroconductivity and electrical characteristics.

The liquid composition may be optionally subjected to a filtration treatment using a filter or the like to remove fine foreign matters contained in the solution.

Furthermore, the liquid composition may be optionally subjected to a defoaming treatment.

The base material to be impregnated with the liquid crystal polyester to be used in the present embodiment includes an inorganic fiber and/or a carbon fiber. Here, the inorganic fiber is a ceramic fiber typified by glass, and examples thereof include a glass fiber, an alumina-based fiber, and a silicon-containing ceramic-based fiber. Among them, a sheet mainly including a glass fiber, namely, a glass cloth is preferable because of large mechanical strength and satisfactory availability.

The glass cloth is preferably one including an alkali-containing glass fiber, a non-alkali glass fiber or a low dielectric glass fiber. It may also be partially mixed with, as a fiber constituting the glass cloth, a ceramic fiber including ceramic other than glass or a carbon fiber. The fiber constituting the glass cloth may be subjected to a surface treatment with a coupling agent such as an aminosilane-based coupling agent, an epoxysilane-based coupling agent or a titanate-based coupling agent.

Examples of a method for producing the glass cloth including these fibers can include a method in which fibers forming a glass cloth are dispersed in water and, if necessary, a sizing agent such as an acrylic resin is added thereto, and the resultant is subjected to sheet making with a paper machine and dried to obtain a nonwoven fabric; and a method using a known weaving machine.

A method for weaving fibers that can be used includes a plain weaving method, a satin weaving method, a twill weaving method, and a mat weaving method. The glass cloth to be preferably used has a weave density of 10 to 100 fibers/25 mm and a mass per unit area of 10 to 300 g/m². The thickness of the glass cloth to be more preferably used is usually from about 10 to 200 μm, and more preferably from 10 to 180 μm.

A glass cloth which is easily available from the market can also be used. As such a glass cloth, various products are commercially available as an insulating impregnated base material for electronic components. They are available from Asahi-Schwebel Co., Ltd., Nitto Boseki Co., Ltd., Arisawa Manufacturing Co., Ltd. and the like. Examples of the commercially available glass cloth having a suitable thickness include those having IPC names of 1035, 1078, 2116 and 7628.

The suitable glass cloth as an inorganic fiber can be typically impregnated with a liquid composition by preparing a dipping bath in which this liquid composition is charged, and dipping the glass cloth in this dipping bath. Here, if the content of the liquid crystal polyester in the liquid composition used, the time of dipping in the dipping bath, and the pull-up rate of the glass cloth impregnated with the liquid composition are appropriately optimized, the adhesion amount of the above-described suitable liquid crystal polyester can be easily controlled.

The resin-impregnated base material 2 can be produced by removing the solvent from the glass cloth thus impregnated with the liquid composition. A method for removing the solvent is not particularly limited, but it is preferably carried out by evaporating the solvent from the viewpoint of a simple operation, and a heating method, a reduced-pressure method, a ventilation method or a method of a combination thereof is used. In the production of the resin-impregnated base material 2, a heat treatment may also be further carried out after removing the solvent. Such a heat treatment makes it possible to increase the molecular weight of the liquid crystal polyester contained in the resin-impregnated base material 2 after removing the solvent. With respect to the treatment conditions according to this heat treatment, for example, a heat treatment method can be carried out under an atmosphere of an inert gas such as nitrogen at 240 to 330° C. for 1 to 30 hours. Here, from the viewpoint of obtaining a metal foil laminate having more satisfactory heat resistance, the heating temperature as the treatment conditions of this heat treatment is preferably higher than 250° C. The heating temperature is more preferably within a range from 260 to 320° C. It is preferable in terms of productivity that the treatment time of this heat treatment be selected from 1 to 10 hours.

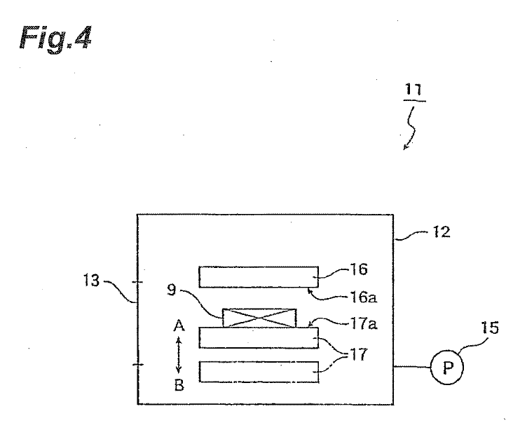

As shown in FIG. 4, a hot press 11 for producing the metal foil laminate 1 as described above includes a rectangular solid chamber 12, and a door 13 is attached onto the side (left side in FIG. 3) of the chamber 12 in an openable and closable manner. A vacuum pump 15 is connected to the chamber 12 so that the pressure in the chamber 12 is reduced to a predetermined pressure (preferably, a pressure of 2 kPa or less). Furthermore, a pair of upper and lower heating plates (an upper heating plate 16 and a lower heating plate 17) are disposed in the chamber 12 opposite each other. Here, the upper heating plate 16 is fixed to the chamber 12 so as not to ascend and descend, while the lower heating plate 17 is provided in an ascendible and descendible manner in the direction of arrow A-B to the upper heating plate 16. A pressure surface 16a is formed on the lower surface of the upper heating plate 16, while a pressure surface 17a is formed on the upper surface of the lower heating plate 17.

The metal foil laminate 1 can be produced by the following procedure using this hot press 11.

First, as shown in FIG. 3, a second stack 9 is prepared that has a layered constitution in which a first stack 8 with a resin-impregnated base material 2 sequentially sandwiched between a pair of copper foils 3A and 3B and between a pair of spacer copper foils 5A and 5B is sequentially sandwiched between a pair of SUS sheets 6A and 6B and between a pair of aramid cushions 7A and 7B. This second stack can be prepared by sequentially stacking each of members constituting the second stack 9 from below. Alternatively, this second stack can also be prepared by sequentially sandwiching a resin-impregnated base material 2 between a pair of copper foils 3A and 3B and between a pair of spacer copper foils 5A and 5B to obtain a first stack 8, and then sequentially sandwiching this first stack 8 between a pair of SUS sheets 6A and 6B and between a pair of aramid cushions 7A and 7B.

Here, each copper foil 3 has a two-layered structure including a mat surface 3a and a shine surface 3b as described above, and the mat surface 3a of each copper foil 3 is allowed to face toward the inside (side of resin-impregnated base material 2). Moreover, each spacer copper foil 5 has a two-layered structure including a mat surface 5a and a shine surface 5b, and the shine surface 5b of each spacer copper foil 5 is allowed to face toward the inside (side of copper foil 3).

Since the aramid cushion 7 is excellent in handling properties, an operation of preparing the second stack 9 can be performed easily and quickly.

The second stack 9 thus obtained is shifted to a hot pressing step (second stack-hot pressing step), and the second stack 9 is hot pressed in the laminating direction thereof (vertical direction in FIG. 3) by the upper heating plate 16 and the lower heating plate 17.

That is, as shown in FIG. 4, first, the door 13 is opened and the second stack 9 is disposed on the pressure surface 17a of the lower heating plate 17. Then, the door 13 is closed and the vacuum pump 15 is operated, thereby reducing the pressure in the chamber 12 to a predetermined pressure. In this state, the lower heating plate 17 is appropriately ascended in the direction of arrow A, and whereby the second stack 9 is fixed with being softly sandwiched between the upper heating plate 16 and the lower heating plate 17. Then, the temperature of the upper heating plate 16 and the lower heating plate 17 is raised. After the temperature is raised to a predetermined temperature, the lower heating plate 17 is further ascended in the direction of arrow A to thereby pressurize the second stack 9 between the upper heating plate 16 and the lower heating plate 17. Thus, the metal foil laminate 1 is formed between the upper heating plate 16 and the lower heating plate 17.

At this time, in the first stack 8, the mat surface 3a of each copper foil 3 is in contact with the resin-impregnated base material 2, and thus the pair of copper foils 3A and 3B is strongly fixed to the resin-impregnated base material 2 by an anchor effect.

In the second stack 9, the spacer copper foil 5 is interposed between each copper foil 3 and each SUS sheet 6 which constitute the metal foil laminate 1, and thus, even if its surface is made uneven by repeatedly using the SUS sheet 6, there is not a possibility that the unevenness is transferred to the surface of the metal foil laminate 1 to cause the unevenness on the copper foil 3. This makes it possible to avoid a case where the appearance of the metal foil laminate 1 is reduced due to the unevenness of the surface of the SUS sheet 6. This also makes it possible to avoid a disadvantage that fine unevenness of the mat surface 5a of each spacer copper foil 5 is transferred to each copper foil 3, because the shine surface 3b of each copper foil 3 is in contact with the shine surface 5b of each spacer copper foil 5.

Since the aramid cushion 7A excellent in heat resistance is interposed between the upper heating plate 16 and the SUS sheet 6A and also the aramid cushion 7B excellent in heat resistance is interposed between the lower heating plate 17 and the SUS sheet 6B, there is not a possibility that the quantity of heat to be transmitted from the upper heating plate 16 or lower heating plate 17 to the metal foil laminate 1 is increased to cause an excessive rise in temperature. This makes it possible to avoid a case where each copper foil 3 is oxidized and colored to thereby impair the appearance of the metal foil laminate 1.

This operation of forming the metal foil laminate 1 is carried out under reduced pressure, thereby making it possible to prevent the copper foil 3 and the spacer copper foil 5 from being oxidized unlike the case of being carried out under an oxygen atmosphere.

The SUS sheet 6 is excellent in heat conductivity and durability, and thus can be used over a long period of time.

With respect to the conditions of the hot pressing treatment in this hot pressing step, it is preferable to appropriately optimize the treatment temperature and treatment pressure so that the obtained laminate exerts satisfactory surface smoothness. This treatment temperature can be based on the temperature conditions of the heat treatment used during producing the resin-impregnated base material 2 to be used in hot pressing. Specifically, assuming that Tmax [° C.] denotes the maximum temperature of temperature conditions according to the heat treatment used during producing the resin-impregnated base material 2, hot pressing is preferably carried out at a temperature which is higher than this Tmax, and more preferably a temperature of Tmax 5[° C.] or higher. The upper limit of the temperature according to this hot pressing can be selected so that it is lower than the decomposition temperature of the liquid crystal polyester contained in the resin-impregnated base material 2 used, and is preferably set to a temperature which is 30° C. or more lower than this composition temperature. As used herein, the decomposition temperature is determined by a known means such as thermogravimetric analysis. The treatment time of this hot pressing is preferably selected from 10 minutes to 5 hours, and the press pressure is preferably selected from 1 to 30 MPa.

After the lapse of a predetermined time under this pressurized state, the temperature of the upper heating plate 16 and the lower heating plate 17 is lowered while maintaining the pressurized state of the second stack 9. Thereafter, the temperature is lowered to a predetermined temperature, and then the lower heating plate 17 is appropriately descended in the direction of arrow B, thereby leading to a state where the second stack 9 is softly sandwiched between the upper heating plate 16 and the lower heating plate 17. Then, the reduced pressure state in the chamber 12 is released and also the lower heating plate 17 is further descended in the direction of arrow B, thereby separating the second stack 9 from the pressure surface 16a of the upper heating plate 16. Finally, the door 13 is opened and the second stack 9 is taken out from the interior of the chamber 12.

After the second stack 9 is taken out, a step of taking out the spacer copper foils 5A and 5B, the SUS sheets 6A and 6B and the aramid cushions 7A and 7B is carried out to separate the metal foil laminate 1 from this second stack 9. At this time, since the shine surface 3b of each copper foil 3 is in contact with the shine surface 5b of each spacer copper foil 5, each spacer copper foil 5 can be easily peeled off from each copper foil 3.

The production procedure of the metal foil laminate 1 is thus completed, and the metal foil laminate 1 is obtained.

### Embodiment 2

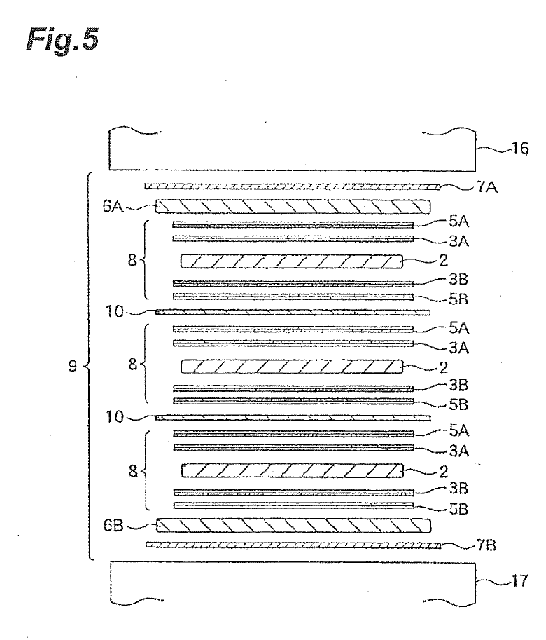

Embodiment 2 will be described with reference to FIG. 5. In Embodiment 2, a three-stage constitution, namely, a case where three metal foil laminates are produced by a single hot pressing will be described. In FIG. 5, the respective members are illustrated with being separated from one another for easy understanding.

A metal foil laminate 1 and a hot press 11 according to Embodiment 2 have the same constitution as that of Embodiment 1.

When the metal foil laminate 1 is produced using this hot press 11, three metal foil laminates 1 are simultaneously produced as described later in accordance with the production procedure of the metal foil laminate 1 in Embodiment 1 described above.

First, as shown in FIG. 5, prepared is a second stack 18 having a layered constitution in which a laminated structure, in which three first stacks 8 with a resin-impregnated base material 2 sequentially sandwiched between a pair of copper foils 3A and 3B and between a pair of spacer copper foils 5A and 5B each are stacked with a SUS sheet (partition plate) 10 having a predetermined thickness (for example, 1 mm) interposed therebetween in the laminating direction thereof (vertical direction in FIG. 5), is sequentially sandwiched between a pair of SUS sheets 6A and 6B and between a pair of aramid cushions 7A and 7B. This second stack 18 can be prepared as follows: first, the SUS sheet 6B is placed on the aramid cushion 7B, each of members constituting the first stack is sequentially stacked thereon from below, the SUS sheet 10 is placed thereon, each of members constituting the first stack is sequentially stacked thereon from below, the SUS sheet 10 is further placed thereon, each of members constituting the first stack is sequentially stacked thereon from below, and finally, the SUS sheet 6A is placed thereon and the aramid cushion 7A is placed thereon.

Alternatively, the second stack 18 can also be prepared as follows: three metal foil laminates 8 with a resin-impregnated base material 2 sequentially sandwiched between a pair of copper foils 3A and 3B and between a pair of spacer copper foils 5A and 5B are prepared, these three first stacks 8 each are stacked with a SUS sheet (partition plate) 10 having a predetermined thickness (for example, 1 mm) interposed therebetween in the laminating direction thereof (vertical direction in FIG. 5), and further this laminated structure is sequentially sandwiched between a pair of SUS sheets 6A and 6B and between a pair of aramid cushions 7A and 7B.

The second stack 18 thus obtained is shifted to a hot pressing step (second stack-hot pressing step), and the second stack 9 is hot pressed in the laminating direction thereof (vertical direction in FIG. 5) by the upper heating plate 16 and the lower heating plate 17, as shown in FIG. 5, as in Embodiment 1 described above. Thus, three metal foil laminates 1 are simultaneously formed between the upper heating plate 16 and the lower heating plate 17.

At this time, in each first stack 8, the mat surface 3a of each copper foil 3 is in contact with the resin-impregnated base material 2, and thus the pair of copper foils 3A and 3B is strongly fixed to the resin-impregnated base material 2 by an anchor effect.

In the second stack 9, the spacer copper foil 5 is interposed between each copper foil 3 and each SUS sheet 6 or the SUS sheet 10 which constitute each metal foil laminate 1, and thus, even if its surface is made uneven by repeatedly using the SUS sheet 6 or the SUS sheet 10, there is not a possibility that the unevenness is transferred to the surface of the metal foil laminate 1 to cause the unevenness on the copper foil 3. This makes it possible to avoid a case where the appearance of the metal foil laminate 1 is reduced due to the unevenness of the surface of the SUS sheet 6 or the SUS sheet 10. This also makes it possible to avoid a disadvantage that fine unevenness of the mat surface 5a of each spacer copper foil 5 is transferred to each copper foil 3, because the shine surface 3b of each copper foil 3 is in contact with the shine surface 5b of each spacer copper foil 5.

Since the aramid cushion 7A is interposed between the upper heating plate 16 and the SUS sheet 6A and also the aramid cushion 7B is interposed between the lower heating plate 17 and the SUS sheet 6B, there is not a possibility that the quantity of heat to be transmitted from the upper heating plate 16 or the lower heating plate 17 to each metal foil laminate 1 is increased to cause an excessive rise in temperature. This makes it possible to avoid a case where each copper foil 3 is oxidized and colored to thereby impair the appearance of the metal foil laminate 1.

This operation of forming these three metal foil laminates 1 is carried out under reduced pressure, thereby making it possible to prevent the copper foil 3 and the spacer copper foil 5 from being oxidized unlike the case of being carried out under an oxygen atmosphere.

The second stack 9 is taken out from the chamber 12, and the aramid cushions 7A and 7B and the SUS sheets 6A and 6B are taken out from the second stack 9 and also the SUS sheet 10 is taken out therefrom to separate each metal foil laminate 1, as in Embodiment 1 described above, and the step of taking out each of the spacer copper foils 5A and 5B from each metal foil laminate 1 is carried out to separate the three metal foil laminates 1 from the second stack 9. At this time, since the shine surface 3b of each copper foil 3 is in contact with the shine surface 5b of each spacer copper foil 5, each spacer copper foil 5 can be easily peeled off from each copper foil 3.

The production procedure of the metal foil laminate 1 is thus completed, and the three metal foil laminates 1 are obtained.

### Other Embodiments

While the case of using the resin-impregnated base material 2 as the insulating base material has been described in First and Embodiment 2s, an insulating base material other than the resin-impregnated base material 2 (for example, a resin film such as a liquid crystal polyester film or a polyimide film) can also be substituted for the resin-impregnated base material or used in combination with the resin-impregnated base material.

While the case of using the copper foil 3 as the metal foil has been described in First and Embodiment 2s, a metal foil other than the copper foil 3 (for example, a SUS foil, a gold foil, a silver foil, a nickel foil or an aluminum foil) can also be substituted for the copper foil or used in combination with the copper foil.

While the case of using the spacer copper foil 5 as the spacer has been described in First and Embodiment 2s, a spacer other than the spacer copper foil 5 (for example, a spacer SUS foil, a spacer gold foil, a spacer silver foil, a spacer nickel foil or a spacer aluminum foil) can also be substituted for the spacer copper foil or used in combination with the spacer copper foil.

While the case of using the SUS sheet 6 as the metal sheet has been described in First and Embodiment 2s, a metal sheet other than the SUS sheet 6 (for example, an aluminum plate) can also be substituted for the SUS sheet or used in combination with the SUS sheet.

While the case of using the aramid cushion 7 as the cushion material has been described in First and Embodiment 2s, a cushion material other than the aramid cushion 7 (for example, an inorganic fiber nonwoven fabric cushion such as a carbon cushion or an alumina fiber nonwoven fabric cushion) can also be substituted for the aramid cushion or used in combination with the aramid cushion.

While the case of using, in the resin-impregnated base material 2, the liquid crystal polyester as the resin with which the inorganic fiber or the carbon fiber is impregnated has been described in First and Embodiment 2s, a resin other than the liquid crystal polyester (for example, a thermosetting resin such as polyimide or epoxy) can also be substituted for the liquid crystal polyester or used in combination with the liquid crystal polyester.

While the case of using the SUS sheet 10 as the partition plate has been described in Embodiment 2, a partition plate other than the SUS sheet 10 (for example, an aluminum plate) can also be substituted for the SUS sheet or used in combination with the SUS sheet.

While the three-stage constitution has been described in Embodiment 2, a multi-stage constitution other than this (for example, a two-stage constitution or a five-stage constitution) can also be used.

### EXAMPLES

Hereinafter, the present invention will be described in more detail based on Examples, but the present invention is not intended to be limited to these Examples.

<Preparation of Resin-Impregnated Base Material>

Into a reactor equipped with a stirring apparatus, a torque meter, a nitrogen gas introducing tube, a thermometer and a reflux condenser, 1976 g of 2-hydroxy-6-naphthoic acid (10.5 mol), 1474 g of 4-hydroxyacetoanilide (9.75 mol), 1620 g of isophthalic acid (9.75 mol) and 2374 g of acetic anhydride (23.25 mol) were charged. After sufficiently replacing the atmosphere in the reactor with a nitrogen gas, the temperature was raised to 150° C. over 15 minutes under a nitrogen gas flow and the mixture was refluxed for 3 hours with being maintained at the temperature (150° C.).

Thereafter, the temperature was raised to 300° C. over 170 minutes while distilling off acetic acid and unreacted acetic anhydride distilled out as by-products, the point of time at which an increase in torque was recognized was regarded as the point of time at which the reaction had been completed, and then contents were taken out. The contents were cooled to room temperature and ground by a grinder to obtain a powder of a liquid crystal polyester having a comparatively low molecular weight. The flow start temperature of the powder thus obtained was measured by a flow tester (“Model CFT-500”, manufactured by Shimadzu Corporation) and found to be 235° C. Solid phase polymerization was carried out by subjecting this liquid crystal polyester powder to a heat treatment under a nitrogen atmosphere at 223° C. for 3 hours. The flow start temperature of the liquid crystal polyester after solid phase polymerization was 270° C.

The liquid crystal polyester thus obtained (2200 g) was added to 7800 g of N,N-dimethylacetamide (DMAc), and heated at 100° C. for 2 hours to obtain a liquid composition. The solution viscosity of this liquid composition was 320 cP. It is to be noted that the melt viscosity is a value measured at a measuring temperature of 23° C. using a B type viscometer (“Model TVL-20”, rotor No. 21 (rotation rate: 5 rpm), manufactured by Toki Sangyo Co., Ltd.).

A glass cloth (glass cloth, 170 μm in thickness, IPC name of 7628, manufactured by Arisawa Manufacturing Co., Ltd.) was impregnated with the liquid composition thus obtained to prepare a resin-impregnated base material. This resin-impregnated base material was dried by a hot-air type dryer, and then subjected to a heat treatment under a nitrogen atmosphere at 290° C. for 3 hours, thereby increasing the molecular weight of the liquid crystal polyester in the resin-impregnated base material. As a result, a heat-treated resin-impregnated base material was obtained.

### Example 1

Using the heat-treated resin-impregnated base material described above, an aramid cushion (aramid cushion, 3 mm in thickness, manufactured by Ichikawa Techno-Fabrics Co., Ltd.), a SUS sheet (SUS304, 5 mm in thickness), a spacer copper foil (“3EC-VLP”, 18 μm in thickness, manufactured by Mitsui Mining & Smelting Co., Ltd.), a copper foil constituting a metal foil laminate (“3EC-VLP”, 18 μm thickness, manufactured by Mitsui Mining & Smelting Co., Ltd.), a resin-impregnated base material constituting a metal foil laminate, a copper foil constituting a metal foil laminate (“3EC-VLP”, 18 μm in thickness, manufactured by Mitsui Mining & Smelting Co., Ltd.), a spacer copper foil (“3EC-VLP”, 18 μm in thickness, manufactured by Mitsui Mining & Smelting Co., Ltd.), a SUS sheet (SUS304, 5 mm in thickness) and an aramid cushion (aramid cushion, 3 mm in thickness, manufactured by Ichikawa Techno-Fabrics Co., Ltd.) were sequentially stacked from below to prepare a second stack. Then, using a high temperature vacuum press machine (“KVHC-PRESS”, 300 mm in length and 300 mm in width, manufactured by Kitagawa Seiki Co., Ltd.), this second stack was integrated by hot pressing under a reduced pressure of 0.2 kPa under the conditions of a temperature of 340° C. and a pressure of 5 MPa for 20 minutes to obtain a metal foil laminate.

### Example 2

A metal foil laminate was produced in the same manner as in Example 1 described above, except that a carbon cushion was used instead of the aramid cushion.

Namely, using the heat-treated resin-impregnated base material described above, a carbon cushion (carbon cushion, 1 mm in thickness, manufactured by NIPPON CARBIDE INDUSTRIES CO., INC.), a SUS sheet (SUS304, 5 mm in thickness), a spacer copper foil (“3EC-VLP”, 18 μm in thickness, manufactured by Mitsui Mining & Smelting Co., Ltd.), a copper foil constituting a metal foil laminate (“3EC-VLP”, 18 μm in thickness, manufactured by Mitsui Mining & Smelting Co., Ltd.), a resin-impregnated base material constituting a metal foil laminate, a copper foil constituting a metal foil laminate (“3EC-VLP”, 18 μm in thickness, manufactured by Mitsui Mining & Smelting Co., Ltd.), a spacer copper foil (“3EC-VLP”, 18 μm in thickness, manufactured by Mitsui Mining & Smelting Co., Ltd.), a SUS sheet (SUS304, 5 mm in thickness) and a carbon cushion (carbon cushion, 1 mm in thickness, manufactured by NIPPON CARBIDE INDUSTRIES CO., INC.) were sequentially stacked from below to prepare a second stack. Then, using a high temperature vacuum press machine (“KVHC-PRESS”, 300 mm in length and 300 mm in width, manufactured by Kitagawa Seiki Co., Ltd.), this second stack was integrated by hot pressing under a reduced pressure of 0.2 kPa under the conditions of a temperature of 340° C. and a pressure of 5 MPa for 20 minutes to obtain a metal foil laminate.

### Comparative Example 1

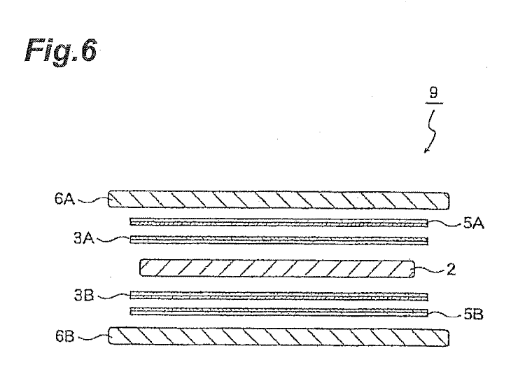

Using the heat-treated resin-impregnated base material described above, a second stack 9 was constituted by the same procedure as in Example 1 described above except that the pair of aramid cushions was omitted as shown in FIG. 6. Then, this second stack 9 was integrated by hot pressing to obtain a metal foil laminate.

Namely, a SUS sheet (SUS304, 5 mm in thickness), a spacer copper foil (“3EC-VLP”, 18 μm in thickness, manufactured by Mitsui Mining & Smelting Co., Ltd.), a copper foil constituting a metal foil laminate (“3EC-VLP”, 18 μm in thickness, manufactured by Mitsui Mining & Smelting Co., Ltd.), a resin-impregnated base material constituting a metal foil laminate, a copper foil constituting a metal foil laminate (“3EC-VLP”, 18 μM in thickness, manufactured by Mitsui Mining & Smelting Co., Ltd.), a spacer copper foil (“3EC-VLP”, 18 μm in thickness, manufactured by Mitsui Mining & Smelting Co., Ltd.) and a SUS sheet (SUS304, 5 mm in thickness) were sequentially stacked from below to prepare a second stack. Then, using a high temperature vacuum press machine (“KVHC-PRESS”, 300 mm in length and 300 mm in width, manufactured by Kitagawa Seiki Co., Ltd.), this second stack was integrated by hot pressing under a reduced pressure of 0.2 kPa under the conditions of a temperature of 340° C. and a pressure of 5 MPa for 20 minutes to obtain a metal foil laminate.

### Comparative Example 2

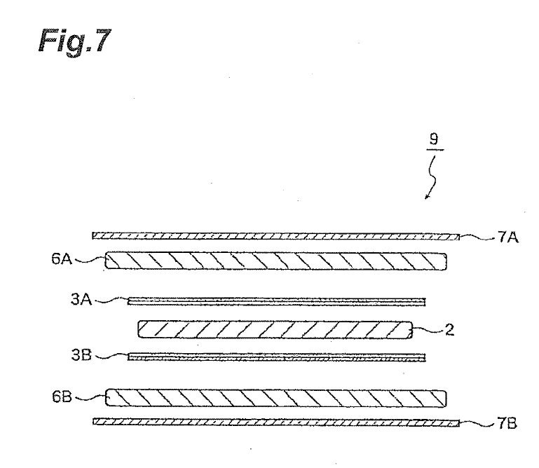

Using the heat-treated resin-impregnated base material described above, a second stack 9 was constituted by the same procedure as in Example 1 described above except that the pair of spacer copper foils was omitted as shown in FIG. 7. Then, this second stack 9 was integrated by hot pressing to obtain a metal foil laminate.

Namely, an aramid cushion (aramid cushion, 3 mm in thickness, manufactured by Ichikawa Techno-Fabrics Co., Ltd.), a SUS sheet (SUS304, 5 mm in thickness), a copper foil constituting a metal foil laminate (“3EC-VLP”, 18 μm in thickness, manufactured by Mitsui Mining & Smelting Co., Ltd.), a resin-impregnated base material constituting a metal foil laminate, a copper foil constituting a metal foil laminate (“3EC-VLP”, 18 μm in thickness, manufactured by Mitsui Mining & Smelting Co., Ltd.), a SUS sheet (SUS304, 5 mm in thickness) and an aramid cushion (aramid cushion, 3 mm in thickness, manufactured by Ichikawa Techno-Fabrics Co., Ltd.) were sequentially stacked from below to prepare a second stack. Then, using a high temperature vacuum press machine (“KVHC-PRESS”, 300 mm in length and 300 mm in width, manufactured by Kitagawa Seiki Co., Ltd.), this second stack was integrated by hot pressing under a reduced pressure of 0.2 kPa under the conditions of a temperature of 340° C. and a pressure of 5 MPa for 20 minutes to obtain a metal foil laminate.

<Evaluation of Appearance of Metal Foil Laminate>

The appearances of the respective metal foil laminates in these Examples 1 and 2 and Comparative Examples 1 and 2 were visually confirmed.

As a result, in Comparative Example 1, the copper foil of the metal foil laminate was partially colored, and thus the appearance of the metal foil laminate was not satisfactory. In Comparative Example 2, the scratch of the SUS sheet was transferred to the copper foil of the metal foil laminate, and thus the appearance of the metal foil laminate was not satisfactory. In contrast, in both of Examples 1 and 2, the metal foil laminates were not colored and scratched, and thus the appearances of the metal foil laminates were satisfactory. However, in Example 2, the carbon cushion was adhered to the heating plates of the hot press.

### INDUSTRIAL APPLICABILITY

A method for producing a metal foil laminate of the present invention can be widely applied to the production of a metal foil laminate to be used as a material for a printed wiring board and other applications.

### REFERENCE SIGNS LIST

1 . . . metal foil laminate, 2 . . . resin-impregnated base material (insulating base material), 3, 3A, 3B . . . copper foil (metal foil), 3a . . . mat surface, 3b . . . shine surface, 5, 5A, 5B . . . spacer copper foil (spacer), 5a . . . mat surface, 5b . . . shine surface, 6, 6A, 6B . . . SUS sheet (metal sheet), 7, 7A, 7B . . . aramid cushion (cushion material), 8 . . . first stack, 9 . . . second stack, 10 . . . SUS sheet (partition plate), 11 . . . hot press, 12 . . . chamber, 13 door, 15 . . . vacuum pump, 16 . . . upper heating plate (heating plate), 16a . . . pressure surface, 17 . . . lower heating plate (heating plate), 17a . . . pressure surface

1. A method for producing a metal foil laminate provided with metal foils on both sides of an insulating base material, comprising:
a second stack-preparing step of preparing a second stack having a layered constitution in which a first stack with the insulating base material sequentially sandwiched between a pair of the metal foils and between a pair of spacers is sequentially sandwiched between a pair of metal sheets and between a pair of cushion materials; and
a hot pressing step of hot pressing this second stack in a laminating direction thereof with a pair of heating plates.

2. The method according to claim 1, wherein the second stack is hot pressed under reduced pressure in the hot pressing step.

3. The method according to claim 1, wherein the metal foil is a copper foil.

4. The method according to claim 1, wherein the spacer is a spacer copper foil or a spacer SUS foil.

5. The method according to claim 1, wherein the metal sheet is a SUS sheet.

6. The method according to claim 1, wherein the cushion material is an aramid cushion.

7. The method according to claim 1, wherein the insulating base material is a prepreg in which a liquid crystal polyester is impregnated into an inorganic fiber or a carbon fiber.

8. The method according to claim 7, wherein the liquid crystal polyester has solubility in a solvent and a flow start temperature thereof is 250° C. or higher.

9. The method according to claim 7, wherein the liquid crystal polyester has structural units shown by Formulae (1), (2) and (3), wherein a proportion of the structural unit shown by Formula (1) is 30.0 to 45.0% by mole, a proportion of the structural unit shown by Formula (2) is 27.5 to 35.0% by mole, and a proportion of the structural unit shown by Formula (3) is 27.5 to 35.0% by mole, based on the total of all the structural units:
—O—Ar¹—CO— (1)
—CO—Ar²—CO— (2)
—X—Ar³—Y— (3)
wherein, Ar¹ represents phenylene or naphthylene, Ar² represents phenylene, naphthylene or a group shown by Formula (4), Ar³ represents phenylene or the group shown by Formula (4), and X and Y each independently represent O or NH, wherein hydrogen atoms bonded to aromatic rings represented by Ar¹, Ar² and Ar³ may be substituted with halogen atoms, alkyl groups or aryl groups
—Ar¹¹—Z—Ar¹²— (4)
wherein, Ar¹¹ and Ar¹² each independently represent phenylene or naphthylene, and Z represents O, CO or SO₂.

10. The method according to claim 9, wherein at least one of X and Y in the structural unit shown by Formula (3) is NH.

11. The method according to claim 7, wherein the liquid crystal polyester contains 30.0 to 45.0% by mole of at least one structural unit selected from the group consisting of a structural unit derived from p-hydroxybenzoic acid and a structural unit derived from 2-hydroxy-6-naphthoic acid, 27.5 to 35.0% by mole of at least one structural unit selected from the group consisting of a structural unit derived from terephthalic acid, a structural unit derived from isophthalic acid and a structural unit derived from 2,6-naphthalenedicarboxylic acid, and 27.5 to 35.0% by mole of a structural unit derived from 4-aminophenol, based on the total of all the structural units.

12. A method for producing a metal foil laminate provided with metal foils on both sides of an insulating base material, comprising:
a second stack-preparing step of preparing a second stack having a layered constitution in which a laminated structure, in which a plurality of first stacks with the insulating base material sequentially sandwiched between a pair of the metal foils and between a pair of spacers are stacked in a laminating direction thereof with a partition plate interposed therebetween, is sequentially sandwiched between a pair of metal sheets and between a pair of cushion materials; and
a hot pressing step of hot pressing this second stack in a laminating direction thereof with a pair of heating plates.
